(19) United States
(12) Patent Application Publication
(10) Pub. No.: US 2020/0070665 A1
(43) Pub. Date: Mar. 5, 2020

(54) Adaptive Reservoir Charging Station

(71) Applicant: II-VI Delaware, Inc., Wilmington, DE (US)

(72) Inventors: Shailesh Patkar, Irwin, PA (US); Yancheng Zhang, State College, PA (US); Giovanni Barbarossa, Saratoga, CA (US); Wen-Qing Xu, Medfield, MA (US); Christopher Koeppen, New Hope, PA (US); Elgin Eissler, Renfrew, PA (US)

(73) Assignee: II-VI Delaware, Inc., Wilmington, DE (US)

(21) Appl. No.: 16/114,516

(22) Filed: Aug. 28, 2018

(51) Int. Cl. B60L 11/18; H02J 7/00

(52) U.S. Cl. CPC B60L 11/185; B60L 2210/10; H02J 7/0013; B60L 11/1811

(57) ABSTRACT

A charging station including a “reservoir” energy supply is proposed. The reservoir supply is formed of one or more rapid charge/discharge batteries that are also able to hold their charge for an extended period of time (as compared to conventional supercapacitors, for example). The reservoir supply is contemplated to accommodate transient increases in power demand when a given charging station has to re-charge several vehicles (for example) at the same time. The rechargeable batteries forming the reservoir are advantageously configured to thereafter be re-charged at a fast rate as well, making them ideal candidates for re-charging from secondary sources (such as, but not limited to, solar, fuel cells, wind, and the like).

### TECHNICAL FIELD

The present invention relates to battery charging stations and, more particularly, to a battery charging station utilizing one or more rechargeable batteries as a reservoir supply of energy to accommodate fluctuations in demand.

### BACKGROUND OF THE INVENTION

The rapid growth in electric cars and other relatively high capacity battery-powered devices is resulting in the need for an extensive network of charging stations that can provide uninterrupted battery charging capability on demand. These charging stations are typically connected to the electric grid or powered by renewable energy sources (e.g., solar, fuel cells, wind turbine, etc.). An electric vehicle charging station (also referred to at times as an “EV charging station”) is typically defined as being one of three different types (as defined by SAE): Level 1 charging stations, Level 2 charging stations, and Level 3 charging stations (also referred to as DC Fast Chargers).

Level 1 chargers use a 120 V AC plug and can be plugged into a standard outlet. These chargers typically delver two to file miles of range per hour of charging and are most often used at home since they take the most time to charge a car's battery and are typically used overnight. Level 2 chargers use a 240 V (residential) or 208 V (commercial) plug and are typically installed by a professional electrician. Level 2 chargers may also be installed as part of a solar panel system. Level 2 chargers can fully charge an electric car battery in as little as two hours, making them an ideal option for both homeowners and businesses who want to offer charging stations to customers/employees who intend to remain at the business for an extended period of time.

Level 3 chargers are commonly referred to as “DC Fast Chargers” (480 V three-phase AC input) that can charge an electric car in just 20 minutes of charging time. However, they are typically only used in commercial and industrial applications since they require highly specialized, high-powered equipment to install and maintain. Moreover, not all electric cars can be charged with the use of DC Fast Chargers. In particular, most plug-in hybrid gas-electric cars do not have the capability to accept this type of charging.

It is expected that the continued adoption of electric cars (and the associated need to frequently re-charge the car's battery) will increase the unpredictability of power demands on aging electric power grid networks. For example, transient increases in power demand to charge electric cars may cause isolated (or not so isolated) residential and commercial power outages due to limitations with respect to load sharing and localized surges. The unintended consequences of temporarily impaired or “closed” charging stations may result in lines of stranded vehicles waiting for available power to be restored to charge their batteries. This could also have a collateral, negative impact on the safety and security of drivers as well as local populations.

Indeed, if all gas stations in the United States were to be replaced by EV charging stations, a total of about 168,000 stations would be required. There is an estimated daily consumption of 380 million gallons of fuel, averaging about 2320 gallons of fuel consumed per gas station per day. Using the EPA's standard conversion factor of 1 gallon of gas being equivalent to 33.7 KWh of electricity, a typical gas station would be required to deliver approximately 78,000 KW (i.e., 78 MW) of electricity per day, and be capable of delivering at least twice this amount (i.e., about 156 MW) to account for peak demand and other contingencies. It is obvious that it is highly impractical for an EV charging station to provide that much power directly from the grid. Therefore, an on-site energy storage, delivery and charging solution (that is also fast and can balance normal and peak demand) is an absolute necessity if electric vehicle charging stations are to function as (or replace) today's gas stations and services in the future.

Beyond electric cars, other high capacity (e.g., tens of KWh) battery-powered devices (e.g., hybrids, plug-in vehicles, neighborhood electric carts, and the like) are evolving as well and are contemplated to even further add to the unpredictability of the demand on charging stations. For the purposes of the present invention, these various types of high capacity rechargeable batteries are collectively referred to below as “end-use batteries”. As a result of the proliferation of end-use batteries, the ability for an EV charging station to meet a variable demand for power at any given time puts additional constraints on the power grid to provide the supply.

### SUMMARY OF THE INVENTION

These and other concerns associated with the impact of an increasing number of battery charging stations on the electric power grid are addressed by the present invention, which relates to a battery charging station including a reservoir power supply taking the form of one or more rechargeable batteries (specifically, rapid charge/discharge, minimal leakage rechargeable batteries) that are used to accommodate localized surges in demand. These rechargeable batteries may be used either alone or in conjunction with traditional charging station configurations, functioning as an adaptable reservoir of charge that can simultaneously and rapidly charge a number of end-use batteries and thus minimize the effects of demand peaks on the charging station itself. Additionally, the utilization of such rechargeable batteries as a reservoir supply allows for a charging station to efficiently change (adapt) the amount of reservoir power by adding (or reducing) the power stored in and supplied by the batteries based on demand considerations at any given time.

In accordance with the principles of the present invention, these rechargeable batteries comprise high energy, high power components that are formed of a chemical system that is able to store charge for an extended period of time with minimal “fading” (i.e., leakage, also referred to as “self-discharging”). One such system utilizes a lithium-selenium battery that is particularly configured to perform “fast” charging of EV batteries (or any other type of end-use battery). The rechargeable battery sources are also configured to thereafter be re-charged at a fast rate as well, making them ideal candidates for use as a reliable “reservoir” supply source at a charging station. The solution of the present invention is an improvement over the prior art use of supercapacitors, for example, that can typically hold their charges for only limited periods of time and are not predictable as a stable reservoir supply source.

An exemplary embodiment of the present invention takes the form of a high power, high capacity DC-to-DC charging station including a reservoir of energy that is supplied separate from an input power source (such as the electric power grid). The reservoir supply is stored in one or more rechargeable batteries, each rechargeable battery formed of rapid charge/discharge anode and cathode materials providing a charge/discharge rate in the range of 0.1 C to 100 C and configured to exhibit a minimal self-discharge rate so that it is a viable long-term supply of energy.

Other and further embodiments of the present invention will become apparent during the course of the following discussion and by reference to the accompanying drawings.

### BRIEF DESCRIPTION OF THE DRAWINGS

Referring now to the drawings,

FIG. 1 is Ragone plot illustrating specific energy vs. specific power for various prior art energy storage technologies, as well as the energy vs. power plots (shown as plots I and II) associated with the system of the present invention;

FIG. 2 is a simplified diagram illustrating the principle of utilizing a reservoir rechargeable battery at a charging station to perform recharging of an end-use battery in accordance with the present invention;

FIG. 3 depicts a set of different examples where a reservoir rechargeable battery is used to charge a single end-use battery or multiple end-use batteries;

FIG. 4 is a graph illustrating the cycling performance at different C-rates for exemplary reservoir rechargeable batteries used in a charging station formed in accordance with the present invention;

FIG. 5 is a simplified diagram of an exemplary charging station formed in accordance with the present invention; and

FIG. 6 illustrates a mobile configuration of a charging station formed in accordance with the present invention, for use as a remote charging station not directly connected to an electric power grid.

### DETAILED DESCRIPTION

A charging station configured in accordance with the present invention includes one or more rapid charge- and discharge-capable rechargeable batteries that function as an independent energy source (hereinafter referred to at times as a “reservoir rechargeable battery”), in particular as a DC-to-DC battery charger source for any type of high capacity end-use battery (e.g., electric vehicle battery, plug-in vehicle battery, hybrid vehicle, cart battery, or the like). In accordance with the present invention, these quick-performance rechargeable batteries function as a “reservoir energy supply” at an EV charging station and can be used to supplement conventional charging systems when there is a significant increase in the demand for the charging service. These rechargeable batteries are also able to be rapidly re-charged (after charging several end-use batteries) using any one of a number of different sources (e.g. conventional electric power grid, photovoltaic solar cells, fuel cells, wind turbines, generators, etc.), thus ensuring that this reservoir supply is at capacity when needed.

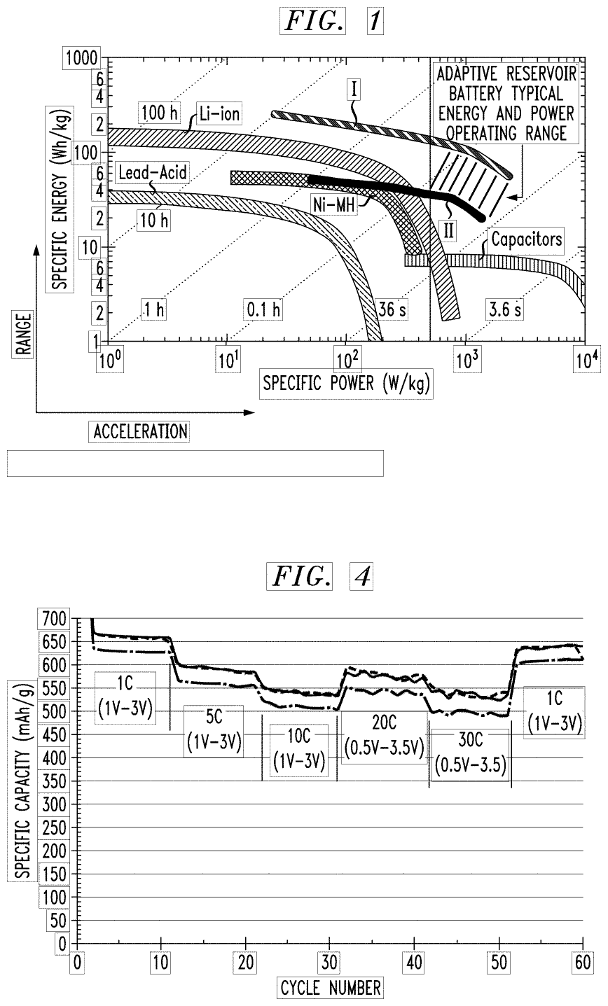

FIG. 1 is a Ragone plot illustrating the comparative performance of current state-of-the-art power and energy storage technologies, including Li-ion batteries, lead-acid batteries, Ni-metal hydride batteries, and capacitors. In particular, the Ragone plot depicts specific energy (also referred to as “energy density”) in Wh/kg as a function of specific power (“power density”) defined in W/kg. While the best-in-class Li-ion batteries provide high energy density (in terms of Wh/kg), the Ragone plot clearly shows that the Li-ion batteries are limited in power density. Capacitors may be able to provide high power, but with relatively low energy density capability (e.g., about 5 Wh/kg). The rechargeable battery used as a reservoir charge supply in a charging station of the present invention is indicated as the area bounded between plots I and II in FIG. 1. This type of energy source is able to provide both high power density (e.g., anywhere from about 10 W/kg to over 1 KW/kg) and high energy density (e.g., tens to hundreds of Wh/kg), a highly desirable combination of performance attributes for the reservoir supply application of the present invention. As shown in FIG. 1, for an exemplary power demand of 500 W/kg (shown as line A in FIG. 1), the inventive reservoir supply exhibits an energy density in the range of 30-150 Wh/kg. An exemplary operating range for the reservoir power supply of the present invention is indicated by the shaded area adjacent to line A. For the purposes of the present invention, “high energy” is defined as an energy in the range of tens to thousands of KWh, and “high power” is defined as a power in the range of KW to GW.

FIG. 2 is a simplified diagram illustrating the principles of using a reservoir supply in accordance with the teachings of the present invention. Here, a rechargeable battery 10 is shown as being charged from an input source 20 (which may be a conventional electric power grid 22, solar cells 24, fuel cells 26, or wind turbines 28, among others sources, for example). Rechargeable battery 10 may comprise a cathode based on the use of “immobilized” selenium, such as that described in US Patent Application Publication 2017/0301914, where the immobilization reduces the shuttle effect between anode and cathode and thus contributes to the extended capability of holding a charge. Advantageously, the use of lithium-selenium batteries with an immobilized selenium anode provide rapid charge and discharge rates (defined as C-rates) that provide high energy and high power capability.

In particular, C-rates are used to define the charge (or discharge) current of a given battery in order to normalize against battery capacity (which may widely vary from battery to battery). The C-rate is a measure of the rate at which a battery is charged (or discharged) relative to its maximum capacity. A 1 C rate means that the charging current will charge a given battery in one hour. For the purposes of the present invention, rates in the range of about 0.1 C to 100 C are contemplated as desirable.

Reservoir rechargeable battery 10 is shown in FIG. 2 as providing a DC-to-DC charging of an end-use battery 30 (such as an electrical vehicle battery). As will be discussed below, advantages including such a reservoir energy supply in terms of a rechargeable battery at a charging station include the ability to rapidly re-charge end-use battery 30 (for example, a full charge in about six minutes for an exemplary electric vehicle battery having a capacity of about 80 Wh), as well as accommodate localized surges and load demands on the electric power grid. It is contemplated that the capacity of reservoir battery 10 should be at least twice that of a typical end-use battery, with a capacity ratio of 4:1 being preferable.

As mentioned above, a significant aspect of the present invention is that a charging station including such a reservoir supply is able to accommodate several end-use batteries that need re-charging at the same time (e.g., when several vehicles arrive at a charging station at the same time). Conventional charging stations, as discussed above, may experience load sharing/surge problems when attempting to service multiple vehicles at the same time. In these scenarios, the ability to utilize a relatively high capacity reservoir supply (for example, about 10 times that of a typical end-use battery) allows for a relatively large number of EV car batteries to be re-charged without a concern for peaking the power demand on the conventional charging station supply.

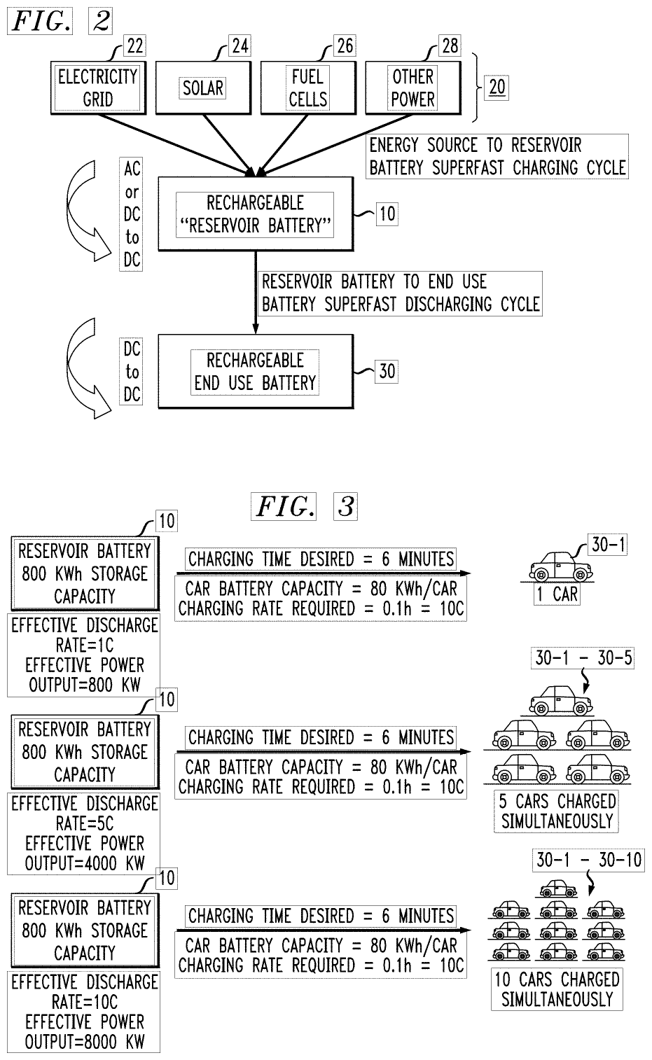

FIG. 3 is a diagram illustrating the principle of utilizing rapid charge/discharge rechargeable battery 10 with one or more end-use batteries 30. In particular, the diagram illustrates the changes in effective power output from rechargeable battery 10 as a function of the number of end-use batteries 30 being recharged. The ability to supplement the charging capabilities of a conventional charging station with a reservoir energy source in accordance with the teachings of the present invention reduces the possibility of a given charging station having to shut down. For the purposes of explanation, rechargeable battery 10 is defined as having an 800 KWh storage capacity and it is presumed that it is designed to provide a rapid charge of 6 min/vehicle (for end-use battery 30 with a charging rate of 10 C and a capacity of 80 KWh). When charging a single end-use battery 30, this rapid charge of battery 30-1 translates to an effective discharge rate of 1 C for rechargeable battery 10, with an effective output power of 800 KW. Moreover, it is to be understood that “reservoir rechargeable battery 10” may comprise several, individual battery sources utilized in any series/parallel combination required to supply the necessary power (for example, a set of eight separate battery elements, each having a capacity of 10 KWh, can then provide a supply an 80 KWh).

The simultaneous charging of five end-use batteries 30-1, 30-2, . . . , 30-5 (under the same requirements, as also shown in FIG. 3) results in an effective discharge rate of 5 C for rechargeable battery 10, with an effective power of 4000 KW. The simultaneous charging of a set of ten separate batteries 30 results, as shown, in rechargeable battery 10 having an effective discharge rate of 10 C and an effective power of 8000 KW. The ability of the reservoir system of the present invention to provide this type of charge on demand limits fluctuations in demand on the conventional charge supply. As also mentioned above, the rapid recharge of batteries 10 allows them to replenish quickly and be available again for use.

FIG. 4 illustrates the performance of an exemplary rechargeable battery comprising a lithium anode and a selenium-based cathode that can be charged and discharged at a 30 C rate (i.e., 2 minutes to charge, 2 minutes to discharge) with high capacity, minimal capacity fading and high recovery, even after cycling for a cumulative 60 cycles.

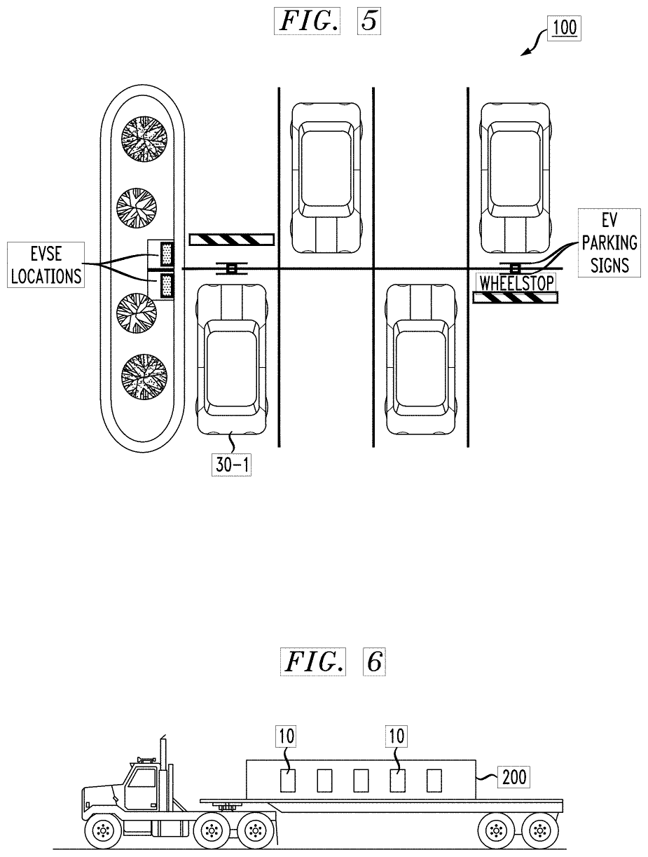

FIG. 5 illustrates an exemplary charging station 100 that may be configured to include a reservoir supply system formed in accordance with the present invention. Here, charging station 100 is shown as including a conventional charge source 110 and a pair of rechargeable batteries 112, 114 used as a reservoir supply of charge. If only a single vehicle 120 is plugged in for recharging its battery, charging station 100 is likely to function properly without load problems. When several cars have arrived at charging station 100, as shown in FIG. 5, rechargeable batteries 112, 114 may be used to provide the additional energy necessary to rapidly charge all vehicles. While only two rechargeable batteries 112, 114 are shown in FIG. 5, it is to be understood that a larger number of batteries may be incorporated into charging station 100, and may be arranged in series, in parallel, or in any suitable series/parallel combination. Indeed, it is contemplated that a specific series/parallel combination of chargeable batteries may be re-configured as necessary by a controller 130 located at charging station 100. Controller 130 may be operated locally, or under the command of a remote system. Indeed, controller 130 may be configured to automatically connect or disconnect one or more of the individual rechargeable batteries from its input power source (such as the electric power grid, for example).

Controller 130 may also include capabilities such as providing wireless data communication with users and other devices, computational capability to determine optimum C rates (which may be a function of the number of vehicles at a particular charging station, the available reservoir charge supply, etc.), safety features for providing automatic shut-down in the presence of certain failure conditions (e.g., heat build-up, electrical overload, etc.). A charging station formed in accordance with the present invention may be configurable (or re-configurable) to provide energy capacity ranging from 1 KWh to 1 GWh (for example).

Another advantage of the use of rapid charge/discharge rechargeable batteries as a reservoir supply in accordance with the present invention is that an exemplary charging station may be configured as a “stand-alone”, remotely-located charging station disconnected from the power grid. The use of a rechargeable battery with a relatively low self-discharge rate in this particular stand-alone configuration provides a reservoir supply particularly useful for temporary situations (e.g., power blackouts, weather-related power failures) or any type of remote need. FIG. 6 illustrates an exemplary stand-alone charging station 200 comprising a plurality of rechargeable batteries 10 of the present invention, as loaded on a truck for delivery to a remote location. During failure of the power grid, the ability to rapidly re-charge these batteries using sources such as solar, wind, gas, and the like is another desirable feature. Examples of large mobile delivery options include, but are not limited to, trucks, ships, airplanes, large drones, helicopters, and the like. Field uses include terrestrial, aquatic and aerial applications.

In summary, the invention has been described with reference to preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

What is claimed is:

1. A high power, high capacity DC-to-DC charging station for recharging high capacity end-use batteries comprising
a reservoir supply of energy separate from an input power source, the reservoir supply stored in one or more rechargeable batteries, each rechargeable battery formed of rapid charge/discharge anode and cathode materials providing a charging/discharging rate in the range of 0.1 C to 100 C; and
at least one separate energy source for recharging the one or more rechargeable batteries of the reservoir supply after discharge.

2. The high power, high capacity DC-to-DC charging station as defined in claim 1 wherein the reservoir supply of energy has a capacity, measured in Wh, that is at least twice the capacity of an end-use battery.

3. The high power, high capacity DC-to-DC charging station as defined in claim 2 wherein the reservoir supply of energy has a capacity that is at least four times greater than the capacity of the end-use battery.

4. The high power, high capacity DC-to-DC charging station as defined in claim 1 wherein the reservoir supply comprises at least one high energy, high power rechargeable battery.

6. The high power, high capacity DC-to-DC charging station as defined in claim 4 wherein the high energy is in the range of tens to thousands of KWh.

7. The high power, high capacity DC-to-DC charging station as defined in claim 4 wherein the high power is in the range of KW to GW.

8. The high power, high capacity DC-to-DC charging station as defined in claim 1 wherein at least one rechargeable battery of the reservoir supply comprises a lithium-containing anode and selenium-containing cathode battery.

9. The high power, high capacity DC-to-DC charging station as defined in claim 8 wherein the selenium-containing cathode is configured as an immobilized selenium cathode.

10. The high power, high capacity DC-to-DC charging station as defined in claim 1 wherein the separate energy source comprises at least one renewable energy source.

11. The high power, high capacity DC-to-DC charging station as defined in claim 10 wherein the at least one renewable energy source comprises one or more sources selected from the group consisting of: solar, fuel cells, wind turbine, and generators.

12. The high power, high capacity DC-to-DC charging station as defined in claim 1 wherein the charging station further comprises
a controller for selecting a charge rate and a discharge rate for the one or more rechargeable batteries based upon a number of end-use batteries to be charged and a capacity of each end-use battery to be charged.

13. The high power, high capacity DC-to-DC charging station as defined in claim 12 wherein the controller is further configured to provide wireless communication with users.

14. The high power, high capacity DC-to-DC charging station as defined in claim 12 wherein the controller is further configured to automatically connect or disconnect the one or more rechargeable batteries from the input power source.

15. The high power, high capacity DC-to-DC charging station as defined in claim 12 wherein the controller is further configured with safety features for automatically shutting down the charging station upon recognition of a system failure.
